(19) United States
(12) Patent Application Publication
(10) Pub. No.: US 2016/0210774 A1
(43) Pub. Date: Jul. 21, 2016

(54) BREAST DENSITY ESTIMATION

(71) Applicant: QT Ultrasound LLC, Novato, CA (US)

(72) Inventors: JAMES W. WISKIN, Salt Lake City, UT (US); MARK W. LENOX, College Station, TX (US); ELAINE IUANOW, Danvers, MA (US); DAVID T. BORUP, Salt Lake City, UT (US); JOHN C. KLOCK, Nicasio, CA (US)

(21) Appl. No.: 14/597,707

(22) Filed: Jan. 15, 2015

(51) Int. Cl. G06T 15/08; G06T 7/20; G06T 7/00

(52) U.S. Cl. CPC G06T 15/08; G06T 7/0012; G06T 7/2006; G06T 2207/10116; G06T 2207/10136; G06T 2207/30068

(57) ABSTRACT

A method for quantitative assessment of breast density can include separating breast voxels and exterior voxels from an image of a patient's breast; and for the breast voxels identified in the image, identifying tissue having high speed value from other tissue. The estimated breast density can be calculated based on the percentage of non-skin breast voxels corresponding to fibroglandular tissue density within the breast.

### BACKGROUND

Breast cancer is a disease best treated by early detection of small lesions and adjunctive treatment regimens personalized to an individual's particular type of cancer to provide patients with optimal treatments and improved prognoses. Risk factors for developing breast cancer include breast density, which has been found to be a significant independent risk factor for the development of breast cancer, increasing cancer risk by 4-6 times. Breast density also plays a role in breast cancer detection since approximately 50% of breast cancers are missed on mammography as they can be obscured by the surrounding dense, white breast parenchyma. Accurate assessment of breast density is critical for accurate risk assessment of a patient developing breast cancer and, therefore, optimal breast cancer prevention and risk reduction strategies for that patient.

### BRIEF SUMMARY

Techniques and systems for quantitative assessment of breast density are described. In some cases, breast density can be estimated from speed of sound images generated from quantitative transmission ultrasound.

A method for quantitative assessment of breast density can include separating breast voxels and exterior voxels from an image of a patient's breast; and for the breast voxels identified in the image, identifying tissue having high speed value from other tissue. The estimated breast density can be calculated based on the percentage of breast voxels corresponding to dense breast tissue. Since the skin tissue is a tissue having a high speed value, the skin tissue voxels may be included as part of the breast voxels identified as tissue having high speed value. Therefore, the method can further include removing the skin tissue voxels so that only the high speed value breast voxels within the breast are used to estimate breast density and, in some cases, identify regions of interest.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a process flow for breast density estimation.

FIGS. 2A-2C show speed images of coronal (2A), and axial/sagittal views (2B,2C) of a phantom with a simple geometric configuration.

FIGS. 3A-3C show binary images corresponding to FIGS. 2A-2C representing the intermediary step of thresholding to segment exterior voxels from phantom voxels.

FIGS. 4A-4C show binary images representing the intermediary step of segmenting high speed voxels from other voxels of the phantom voxels of FIGS. 3A-3C.

FIGS. 5A-5C show binary images representing the high speed voxels used in calculating amount of dense tissue for the three views—i.e., ‘skin’ is removed.

FIGS. 6A-6C show a coronal, axial, and sagittal view, respectively, of grayscale speed images of one example of a heterogeneous breast.

FIGS. 7A-7C illustrates an example of segmentation in the heterogeneous breast of FIGS. 6A-6C, where the high speed tissue (excluding skin) is segmented out.

FIGS. 8A-8C show a coronal, axial, and sagittal view, respectively, of grayscale speed images of another example of a heterogeneous breast.

FIGS. 9A-9C illustrates the segmented high speed tissue including the skin generated using the speed images of FIGS. 8A-8C.

FIGS. 10A-10C illustrates the segmented tissue excluding the skin shown in the images of FIGS. 9A-9C.

FIG. 11 shows an example computing system through which breast density estimation may be carried out.

FIG. 12 illustrates one system that may be used to acquire a 3D map of the breast speed.

FIG. 13 illustrates a process flow diagram that can be carried out by an acquisition control system of a quantitative transmission ultrasound (QTUS) system such as shown in FIG. 12.

FIG. 14 shows a comparison of a quantified Breast Imaging-Reporting and Data System (BI-RADS®) mammographic density against an example quantified breast density obtained through a QTUS system as described herein.

### DETAILED DISCLOSURE

Techniques and systems for quantitative assessment of breast density are described. An accurate determination of breast density is a valuable and important tool in assessing a patient's risk of developing breast cancer. Certain implementations provide a standardized quantitative method for assessing breast density, improving breast care by providing patients with accurate breast health information. A radiologist may reproducibly and relatively accurately determine the ratio of dense to fatty tissue in a breast. Advantageously, in some implementations, breast imagers are also provided with the ability to detect lesions in the presence of dense breast parenchyma, which is an important clinical step for early detection, as well as for the accurate assessment of breast density and subsequent implementation of optimal risk reduction strategies.

In the following description for simplicity, parenchyma/fibroglandular tissue is considered ‘dense’ tissue primarily to signify that this tissue is included in the quantitative estimate for breast density (e.g., that the quantitative estimate for breast density may be written as (total volume of ‘dense’ tissue)/(total volume of the breast)), rather than to signify that the tissue is ‘dense’ in the sense of mechanical properties, and should not be confused with the adjective ‘dense’ used to describe ‘mammographically dense’ breasts as a whole.

Breasts are inherently three dimensional (3D). However, mammography, the imaging modality upon which the presently accepted method of breast density determination is based, yields two dimensional (2D) projections of the 3D breast or, in the case of breast tomosynthesis, a combination of additional oblique views of the breast from −20 to +20 degrees. In either case, the radiologist is required to estimate the percentage of dense tissue from 2D projections of the 3D object (breast). For cylinders and other objects that are really 2D in character, estimating density from 2D projections can yield relatively accurate results.

For the breast, however, which is a 3D structure, the fibroglandular tissue tends not to be uniformly or evenly distributed. Instead, breast tissue is anatomically comprised of 12-20 branching ductal systems with the ductal systems ending in terminal duct lobular units. The entire ductal system then converges at the nipple. This 3D anatomic configuration can be extremely problematic for the process of estimating volume from 2D projections. For example, a 2D projection of a breast will show an object that is seemingly solid, whereas in fact the object is full of three dimensional gaps that represent fatty lobules filling in the space between the ducts, and lobular (fibroglandular) dense elements of the breast. Such topological disparity between what is seen in projection versus 3D reality leads to a tendency for the radiologist to greatly over-estimate breast density. Furthermore, even in the case of true 3D solids (such as cones) there is a tendency to overestimate volumes based on projections.

Advantageously, the described techniques enable improved estimation of breast density through the use of 3D maps of breast speed (e.g., the speed of sound and attenuation through the breast). In some cases, breast density can be estimated from speed of sound images generated from quantitative transmission ultrasound (QTUS).

A speed of sound image comprises a 3D map with unit volumes referred to as voxels, each voxel representing a single data point on the 3D map. For the speed of sound image or other sound map, the voxel can contain a vector with values representing various properties including speed and attenuation. In some cases, other data may be captured and contained in the voxels.

Note that, as used herein, in some cases, the term pixel is used as an indication that the voxels which comprise the 3D image maps are portrayed in a viewer as pixels on a screen. Furthermore the techniques discussed herein can be conducted in full 3D mode, and thus the term voxel is used predominantly. These techniques can also be carried out in 2D planes that comprise the 3D sound map (including one or more of speed of sound map, attenuation map, or reflectivity map). Accordingly, such 2D methods are included in this disclosure.

In order to estimate breast density using a speed map acquired from imaging a patient's breast, the described techniques involve identifying from the image, the regions corresponding to the breast and regions corresponding to dense breast tissue from the regions identified as corresponding to the breast. The percentage of tissue identified as being dense can then be easily calculated.

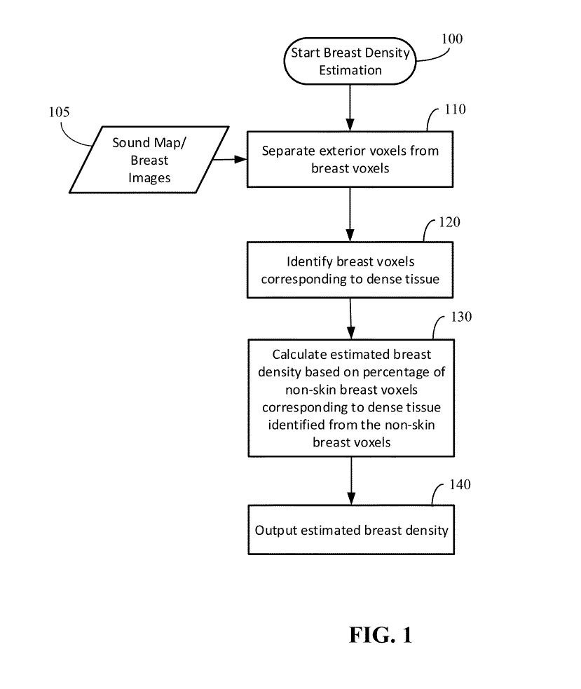

FIG. 1 illustrates a process flow for breast density estimation. Breast density estimation (100) can begin by separating exterior voxels in a sound map 105 of a patient's breast from the breast voxels (110). The sound map 105 can be accessed wired or wirelessly by, or stored at, a computing device carrying out the breast density estimation (100). As used herein, a sound map refers to a map, or image, generated through ultrasound. The sound map 105 can include a speed image, an attenuation image, or a reflection image; both a speed image and an attenuation image; or all three of a speed image, an attenuation image, and a reflection image. For purposes of breast density estimation, at least the speed image is included as part of the sound map.

The separation of the exterior voxels from the breast voxels may be performed by segmentation. In one implementation, the speed image alone can be used for segmentation. In other implementations, the speed and attenuation images are used. For example, in one case, the attenuation image may be read by the computing system and if the value at a particular pixel/voxel is larger than some predetermined (very small) value—e.g. corresponding to the attenuation of water, the pixel/voxel is considered to be part of the breast tissue. Some pixels/voxels that are part of the breast may have small attenuation values that approach water (a possible coupling medium). To minimize the error introduced by identifying a breast pixel/voxel as an exterior pixel/voxel when the attenuation values, alone, are used to separate the exterior pixels/voxels from breast pixels/voxels, various techniques can be implemented.

In one such technique, the convex nature of the breast is used to identify pixels/voxels associated with the breast. In this case, a boundary can be identified between the exterior (having very small attenuation values) and the breast (having, at least at the skin, a high attenuation value). Then, pixels/voxels at positions within the boundary can be identified as breast voxels and pixels/voxels at positions outside the boundary can be identified as exterior voxels, thereby separating exterior voxels from the breast voxels.

In another technique when using the attenuation values for separation of breast voxels from exterior voxels, the morphological operations of opening and/or closing may be used. Opening involves erosion followed by dilation to remove small objects from the foreground of an image. This morphological operation tends to reduce the edges or boundaries of foreground (bright) regions. Closing involves dilation followed by erosion to remove small holes in the foreground. This morphological operation tends to enlarge the boundaries of foreground (bright) regions.

The morphological operations of opening and closing use two inputs: the image to be eroded or dilated and a structuring element (or “kernel”). The structuring element is a set of point coordinates that may be represented by a polygonal or circular element. In one case, the sound map can be converted to a binary image through thresholding. For example, a grayscale image can be transformed into a binary image using a value of 100. Once the sound map is converted to the binary image, a closing can be applied to classify parts of the breast as foreground even though, due to the voxel's attenuation value being similar to a background attenuation value, the voxel would appear to be background after the thresholding.

In some cases, a reflection image can be used to segment out the breast tissue from the exterior volume. For example, when a QTUS system is used to generate a speed map of a breast, reflection images are also generated. These images may be used to segment breast tissue from the surrounding exterior. For example, the envelope of the reflected signal can be used to isolate the breast tissue from the exterior volume.

Registration (or other means to indicate relationship) between pixels/voxels of the reflection images and the speed of sound/attenuation images can enable—or the inclusion of reflection data in the tuple of the speed map voxel can assist—the application of the segmentation of the reflection image to the speed image. That is, the reflection image could be registered to the speed/attenuation image, so that the boundary of the breast tissue as determined by the reflection image coincides with the boundary of the breast tissue as determined by the speed/attenuation image. In this embodiment the speed image and the attenuation image are determined simultaneously as being related to the real and imaginary parts of a single complex variable. Thus speed and attenuation images are co-registered automatically.

After the image is separated and, in some cases, segmented, into breast voxels and exterior voxels (110), breast voxels corresponding to dense tissue are identified (120). The identification of dense tissue within the breast voxels can be determined using the speed of sound data (e.g., speed image) since higher speed represents denser tissue. In one implementation, a minimum speed and a maximum speed is determined from the voxels. For voxels having a speed above a certain value, those voxels can be identified as dense breast tissue. In some cases, the average value can be calculated for the voxels identified as dense breast tissue. In addition estimated breast density can be calculated by dividing the number of voxels identified as dense breast tissue by the total number of voxels identified as breast tissue (130).

Since the skin tissue is a tissue having a high speed value, the skin tissue voxels may be included as part of the breast voxels identified as dense breast tissue. Therefore, the method can further include removing the skin tissue voxels so that only the high speed value breast voxels within the breast are used to estimate breast density in operation 130. In one implementation, the skin tissue voxels are identified through the process that identifies the boundary between the exterior voxels and the breast voxels. For example, if a voxel is identified as a boundary voxel during the process of separating exterior voxels from breast voxels (or in some cases simply identified as being contiguous to a voxel identified as a boundary voxel) and also identified has having a high speed (i.e., a speed higher than a particular value), that voxel can be omitted from the calculation of estimated breast density.

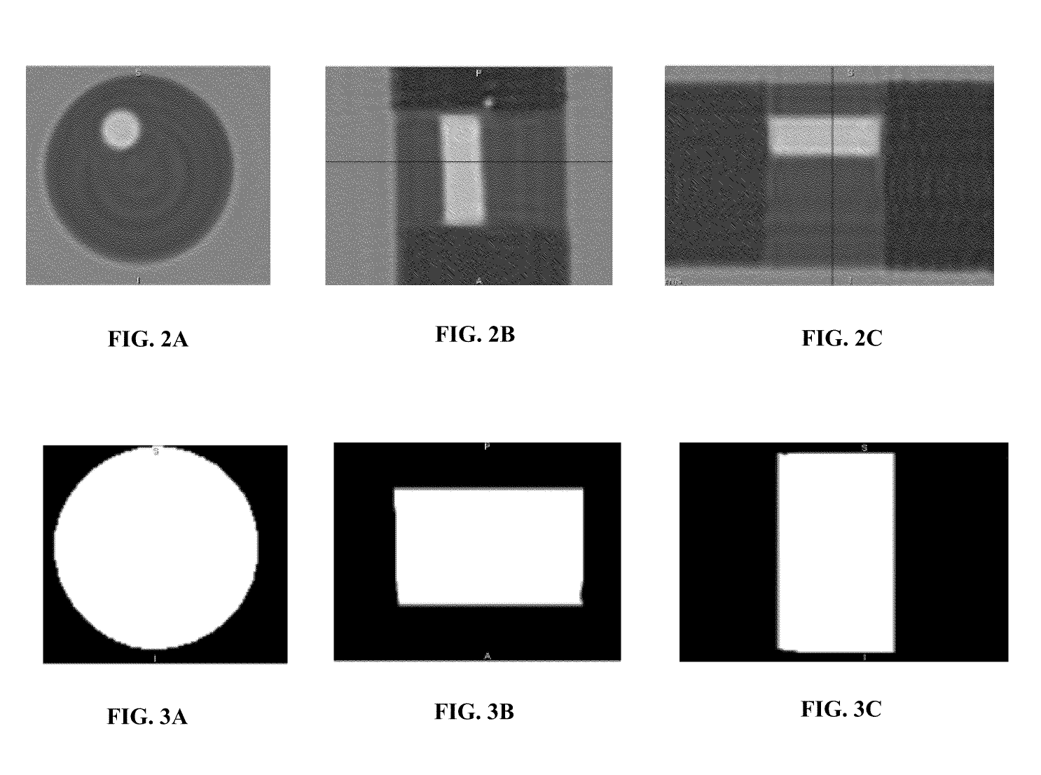

FIGS. 2A-2C show speed images of coronal (2A), and axial/sagittal (2B,2C) views of a phantom with a simple geometric configuration; FIGS. 3A-3C show binary images corresponding to FIGS. 2A-2C representing the intermediary step of thresholding to segment exterior voxels from phantom voxels. The thresholding identifies the voxels/pixels corresponding to the phantom (phantom voxels) (see e.g., operation 110 of FIG. 1).

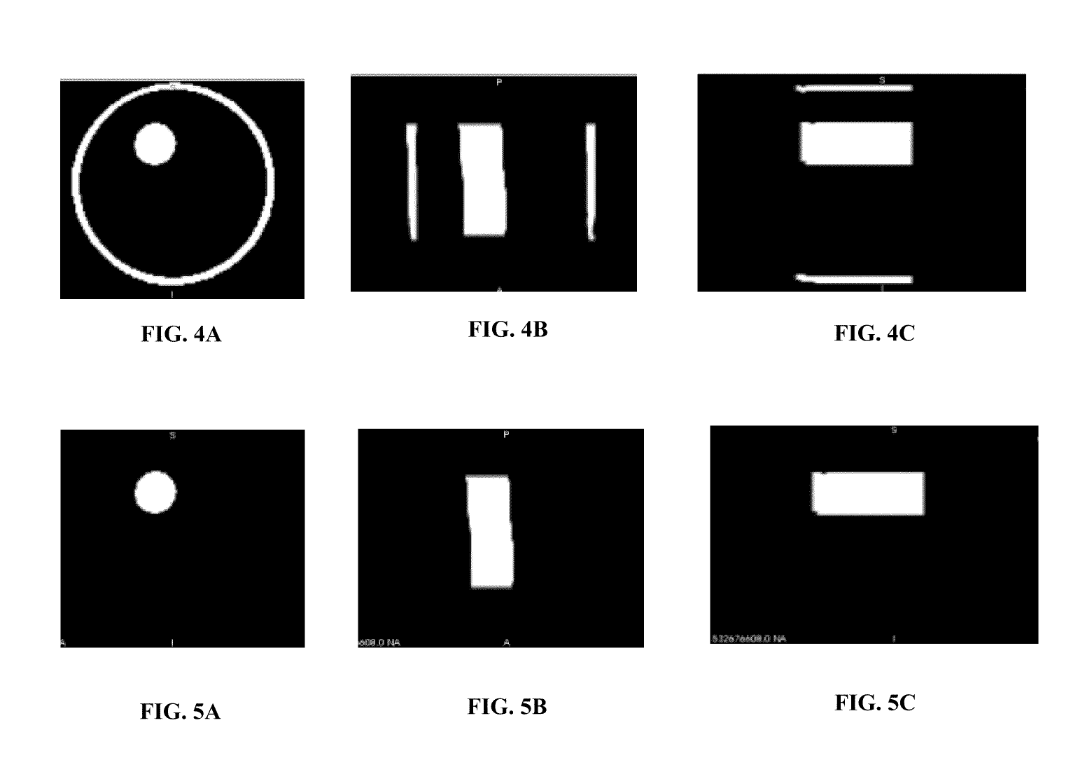

FIGS. 4A-4C show binary images representing the intermediary step of segmenting high speed voxels from other voxels of the phantom voxels of FIGS. 3A-3C. Here, a voxel indicated as being a phantom voxel is analyzed, using the speed data, to identify high speed voxels (see e.g., operation 120 of FIG. 1). In the images, it can be seen that a test phantom tissue and the exterior “skin” of the phantom is identified. FIGS. 5A-5C show binary images representing the high speed voxels used in calculating amount of dense tissue for the three views (e.g., operation 130 of FIG. 1). At this point, the skin is removed so that only the high speed “dense tissue” remains for the calculation.

From the knowledge of the dimensions of the component parts of the phantom, the accuracy of the algorithm was verified. The percentage of high speed tissue was estimated by the algorithm at 4.09%. The geometric shapes gave an estimate of 3.96%.

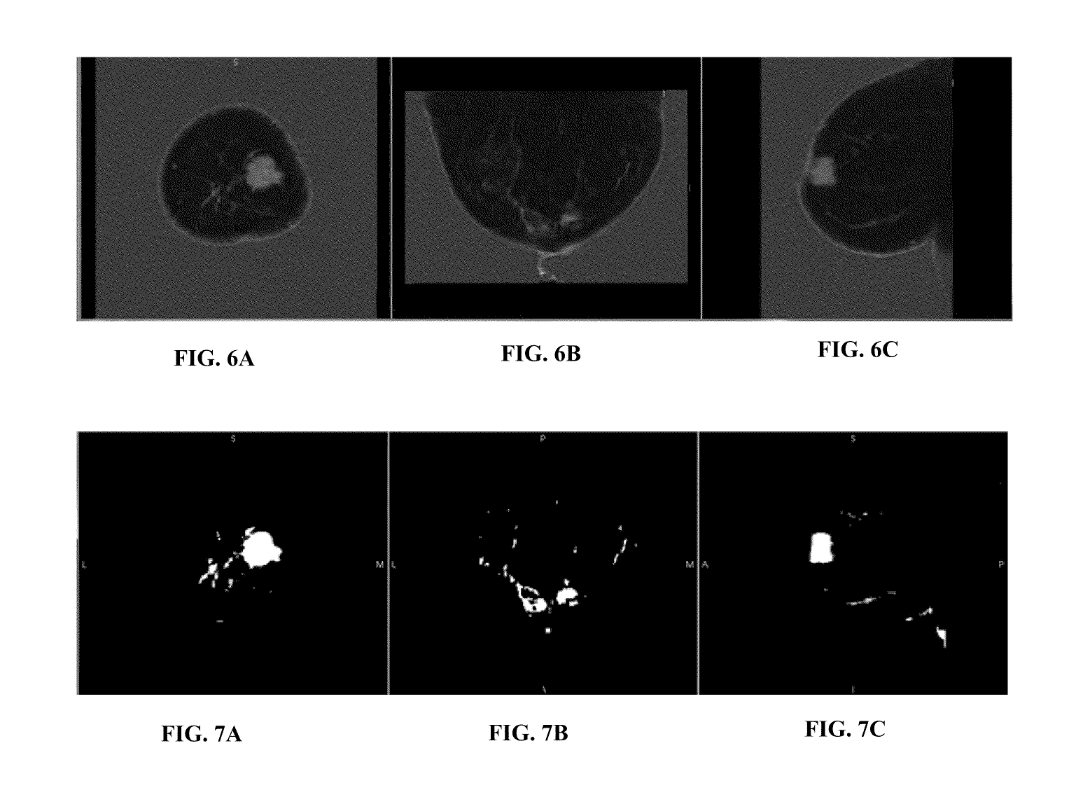

FIGS. 6A-6C show a coronal, axial, and sagittal view, respectively, of grayscale speed images of a heterogeneous breast. In the images, the lighter colors indicate higher speed (more “stiff”) breast tissue, and the gray area surrounding the breast is the exterior volume, the darker tissue shows fat tissue, which has a lower speed of sound than water.

FIGS. 7A-7C illustrates an example of segmentation in the heterogeneous breast of FIGS. 6A-6C, where the high speed tissue is segmented out. This segmented image can be used to calculate the breast density since all that are shown are the denser parts of the breast.

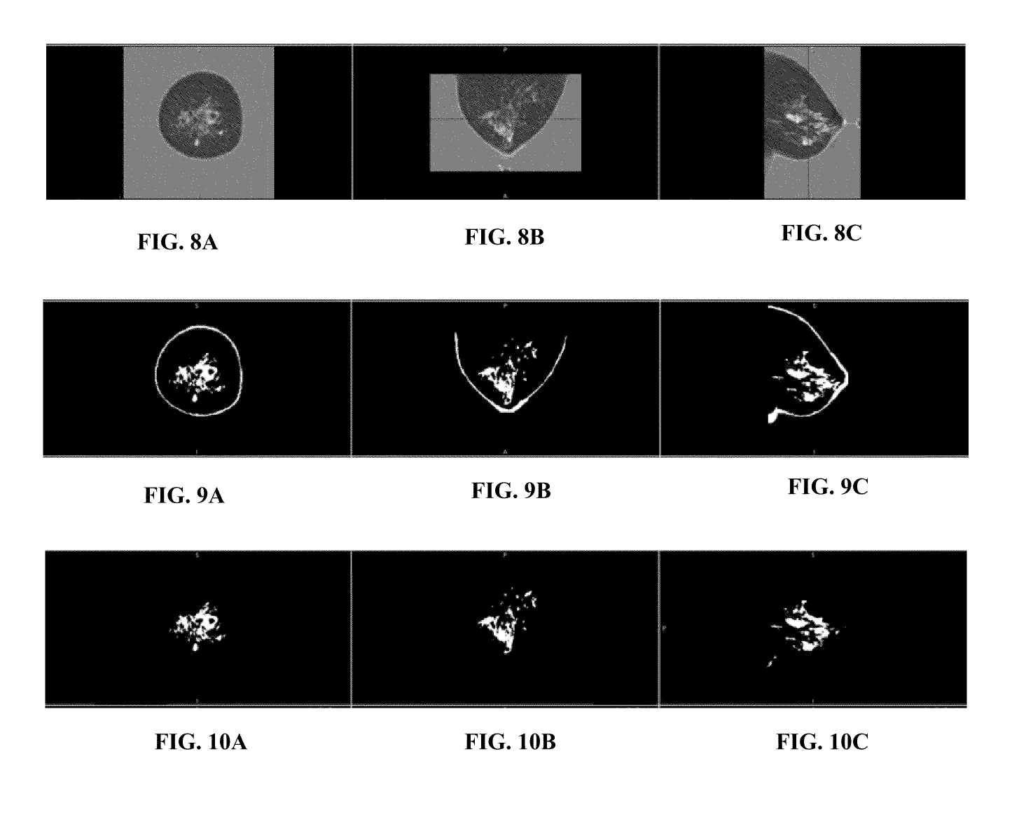

FIGS. 8A-8C show a coronal, axial, and sagittal view, respectively, of grayscale speed images of another example of a heterogeneous breast. Applying the process 100 of FIG. 1, the speed map 110, represented by the speed images of FIGS. 8A-8C, is used to identify breast voxels from exterior voxels. For example, the breast tissue can be separated from the surrounding exterior volume using the attenuation image by thresholding. Then, the high speed voxels (indicating denser breast tissue) are segmented, for example as described with respect to operation 120. FIGS. 9A-9C illustrates the segmented high speed tissue including the skin generated using the speed images of FIGS. 8A-8C. To enable calculation of the breast density, the skin is removed from the image. FIGS. 10A-10C illustrates the segmented tissue excluding the skin shown in the images of FIGS. 9A-9C. This segmented image can be used to calculate the breast density.

Accordingly, segmentation can be performed to separate exterior voxels from breast voxels and/or to ensure that there are no ‘holes’ in the interior of the breast (e.g., by assuming the convex nature of the breast and/or morphological operations). Thus, it is assumed that there are no voids interior to the breast and this condition can be enforced via for example, by assuming convexity or morphological operations. In addition, the voxels which are part of the skin can be set apart. This leaves the non-skin breast voxels for use in the calculations of breast density.

Process flow 100 described with respect to FIG. 1, as well as the processes described with respect to the examples shown in FIGS. 2A-C to 10A-C may be implemented in the form of computer-executable instructions, such as program modules, that are executed by one or more computers or other devices.

In some embodiments, the machine/computer system can operate as a standalone device. In some embodiments, the machine/computer system may be connected (e.g., using a network) to other machines. In certain of such embodiments, the machine/computer system may operate in the capacity of a server or a client user machine in server-client user network environment, or as a peer machine in a peer-to-peer (or distributed) network environment.

The machine/computer system can be implemented as a desktop computer, a laptop computer, a tablet, a phone, a server, or any other machine capable of executing a set of instructions (sequential or otherwise) that specify actions to be taken by that machine, as well as multiple machines that individually or jointly execute a set (or multiple sets) of instructions to perform any one or more of the methods described herein.

The computer system can have hardware including one or more central processing units (CPUs) and/or digital signal processors (DSPs), memory, mass storage (e.g., hard drive, solid state drive), I/O devices (e.g., network interface, user input devices), and a display (e.g., touch screen, flat panel, liquid crystal display, solid state display). Elements of the computer system hardware can communicate with each other via a bus.

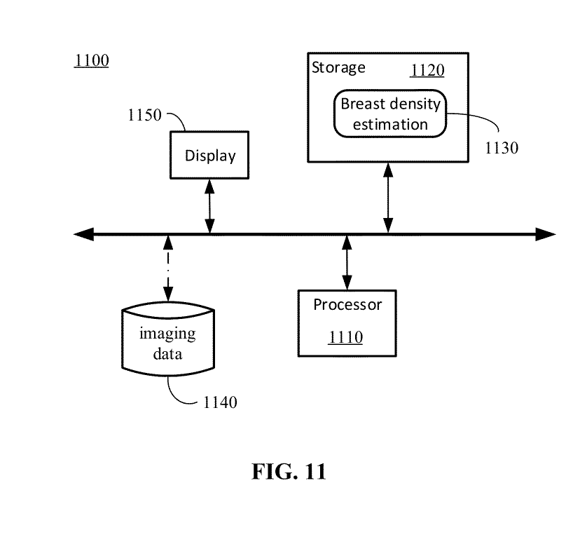

For example, FIG. 11 shows an example computing system through which lesion identification may be carried out. In some implementations, the computing system may be embodied, at least in part, as a viewing station and/or picture archival and communication system (PACS). PACS refers to the software tools and environment providing storage, retrieval management, distribution, and presentation of medical images. PACS software provides an access point across multiple sites and platforms to the imaging (and imaging-related) data stored on one or more storage systems managed by the PACS software. The PACS' storage systems contain archives for storage and retrieval of images, documentation, and reports, which are generally accessed via secure networks. One or more secure networks (e.g., intranet, local area network, wide area network, etc.) are used to communicate between various devices and computing systems. The PACS generally includes and/or communicates with one or more imaging systems such as ultrasound systems, magnetic resonance imaging (MRI) systems and computed tomography (CT) scan equipment; and one or more computing devices (including workstations and portable computing devices).

Referring to FIG. 11, the computing system 1100 can include a processor 1110 and a storage system 1120 in which a breast density estimation module 1130 may be stored. Examples of processor 1110 include general purpose central processing units, application specific processors, and logic devices, as well as any other type of processing device, combinations, or variations thereof. The processor 1110 processes data according to instructions of the lesion determiner module 1130.

Storage system 1120 includes any computer readable storage media readable by the processing system 1120 and capable of storing software, including breast density estimation module 1130. Storage system 1120 may include volatile and nonvolatile, removable and non-removable media implemented in any method or technology for storage of information, such as computer readable instructions, data structures, program modules, or other data. Examples of storage media include random access memory (RAM), read only memory (ROM), magnetic disks, optical disks, CDs, DVDs, flash memory, solid state memory, phase change memory, or any other suitable storage media. Certain implementations may involve either or both virtual memory and non-virtual memory. In no case do storage media consist of a propagated signal or carrier wave. In addition to storage media, in some implementations, storage system 1120 may also include communication media over which software may be communicated internally or externally.

Storage system 1120 may be implemented as a single storage device but may also be implemented across multiple storage devices or sub-systems co-located or distributed relative to each other. Storage system 1120 may include additional elements, such as a controller, capable of communicating with processor 1110.

A database 1140 storing speed of sound, reflection, and other imaging data (i.e., images—speed of sound, attenuation and/or reflection) from a QTUS system (or other system providing sound maps) can be coupled to the system via wired or wireless connections. In some cases, the database 1140 can be part of a PACS with which system 1100 communicates.

Visual output can be provided via a display 1150. Input/Output (I/O) devices (not shown) such as a keyboard, mouse, network card or other I/O device may also be included. It should be understood that any computing device implementing the described system may have additional features or functionality and is not limited to the configurations described herein.

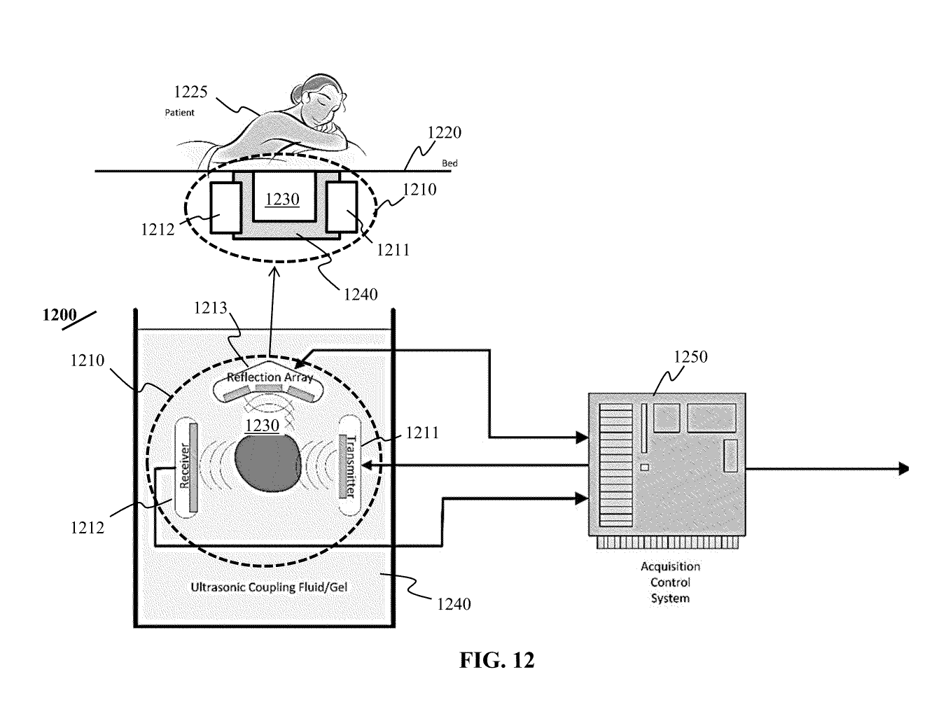

FIG. 12 illustrates one system that may be used to acquire a 3D map of the breast speed. It should be understood that the described techniques for estimation of breast density may be applied to any 3D map of breast speed, irrespective of its method of acquisition. Referring to FIG. 12, a 3D map of breast speed can be acquired using a QTUS system 1200. Image Data from the QTUS system can be provided to a viewing station and/or a PACS through which the breast estimation techniques can be carried out or accessed.

A QTUS system performs both reflection and transmission ultrasound methods to gather data. The reflection portion directs pulses of sound wave energy into tissues and receives the reflected energy from those pulses—hence it is referred to as “reflection ultrasound.” Detection of the sound pulse energies on the opposite side of a tissue after it has passed through the tissue is referred to as “transmission ultrasound.”

In particular, QTUS uses inverse scatter technology providing transmission information (speed of sound and attenuation) mapping of breast tissue, which also serves as a data set to reconstruct 3D breast ultrasound images using the speed data to create a reflection image volume (a reflection image corrected for refraction by the speed of sound mapping).

QTUS enables evaluation of tissue in clinical ultrasound by offering high spatial and contrast resolution, artifact-free, with absolute spatial registration (no image warping or stretching) quantitative imaging. Advantageously, the resulting images can be used for estimating breast density.

Imaging components 1210 of the QTUS system 1200, such as a transmitter 1211, receiver 1212, and reflection array 1213, can be disposed beneath a bed 1220 on which a patient 1225 can lay. The patient 1225 can be scanned in the prone position, resulting in a comfortable procedure. The imaging components 1210 (e.g., the transducers of QTUS system 1200) are arranged so that data may be obtained 360° around a receptacle 1230 in the bed 1210; and are coupled to the patient with an ultrasonic coupling medium 1240 (fluid or gel), at least some of which is disposed in the receptacle 1230.

An acquisition control system 1250 operates the various imaging (and data acquisition) components 1210 (e.g., the transducers) and can control their physical motion (when components 1210 are arranged in a rotating configuration). The acquisition control system 1250 can automate a scan in response to a start signal from an operator. This automated acquisition process does not require operator interaction during the scanning procedure. Once the scan is complete, the acquisition control system 1250 can compute the reflection, speed, and attenuation results from the collected data. The acquisition protocol enables temporal comparisons of 3D data sets; and these data sets can be compared in the same plane and orientation as those acquired with other 3D modalities, such as magnetic resonance imaging (MRI).

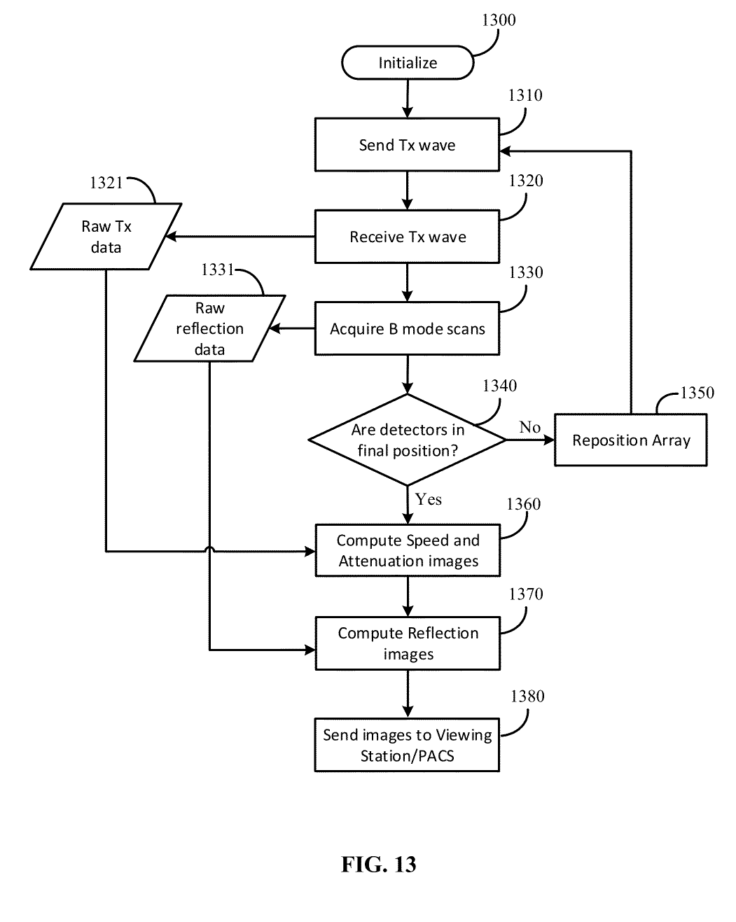

FIG. 13 illustrates a process flow diagram that can be carried out by an acquisition control system of a QTUS system such as shown in FIG. 12. In response to receiving an indication to initiate automated scanning (e.g., from an operator), an acquisition control system, such as system 1250, can initialize (1300) and send a transmission wave from a specified angle about a patient (1310), for example from one or more transmitters (such as transmitter 1211). As the receiver(s) 1212 sense the signal transmitting through the patient (1320), raw transmission data 1321 is captured. Then, B mode scans, for example using transceivers 1213, are acquired (1330) to obtain raw reflection data 1331. Of course, in some cases, the B mode scans may be performed before the transmission ones.

The acquisition control system determines whether the detectors are in the final position (1340). For a rotating system, such as shown in FIG. 12, the acquisition control system can communicate with a motor control of the platform on which the active components are provided so that a current and/or next position of the platform is known and able to be actuated. For a fixed system, the acquisition control system determines the selection of the active arrays according to an activation program. Accordingly, the “detection” may be based on information provided by the motor control, position sensors, and/or a position program (e.g., using counter to determine whether appropriate number of scans have been carried out or following a predetermined pattern for activating transceivers). If the detectors are not in final position, the acquisition control system causes the array to be repositioned (1350), for example, by causing the platform to rotate or by selecting an appropriate array of transceivers of a fixed platform configuration. After the array is repositioned, the transmission wave is sent (1310) and received (1320) so that the raw transmission data 1321 is collected and B mode scans are acquired (1330) for raw reflection data 1331. This repeats until the detectors are determined to be in the final position.

Once all the data is collected (and the detectors completed the final position), speed and attenuation images can be computed (1360) using the raw transmission data 1321; and reflection images are computed (1370) using the raw reflection data 1331. The reflection images are corrected for refraction with the aid of the speed of sound images. In some cases, both the original uncorrected reflection images and the refraction corrected reflection images may be available and sent (along with speed and attenuation images) to a viewing station and/or PACS (1380).

A greater understanding of the present invention and of its many advantages may be had from the following example, given by way of illustration. The following example is illustrative of some of the systems, methods, applications, embodiments and variants of the present invention. They are, of course, not to be considered in any way limitative of the invention. Numerous changes and modifications can be made with respect to the invention.

### Example

### Density Measurements

For the example density measurements, a ‘quantified’ Breast Imaging-Reporting and Data System (BI-RADS®) score is compared to the quantitative breast density (QBD) score obtained as described herein using images from a QTUS system.

Seventeen volunteers were quantitatively evaluated by associating a quantitative value with each BI-RADS mammographic density score. The BI-RADS mammographic density scores range from 1 to 4. A score of 1 indicates a breast that is almost entirely of fat, where glandular tissue is less than 25%. For the example study, the score of 1 was assigned a quantitative value of 12.5%. A score of 2 indicates a breast with scattered fibroglandular tissues, ranging from 25%-50% of the breast. For the example study, the score of 2 was assigned a quantitative value of 37.5%. A score of 3 indicates various glandular and fibrous tissues, ranging from 51%-75% of the breast. This type of breast may be termed heterogeneously dense, indicating that fibroglandular tissue is prevalent throughout the breast. For the example study, the score of 3 was assigned a quantitative value of 62.5%. A score of 4 indicates that the breast contains greater than 75% fibroglandular tissue, which often results in a reduction of the mammogram's sensitivity. For the example study, the score of 4 was assigned a quantitative value of 87.5%.

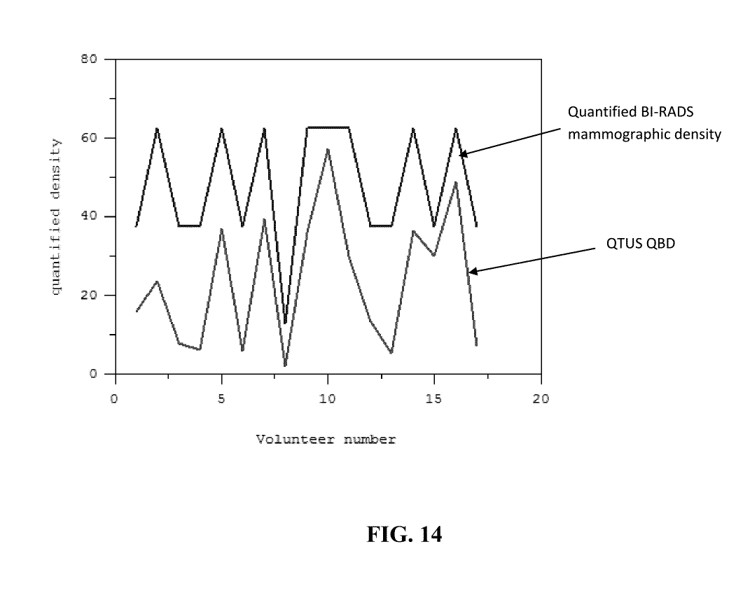

FIG. 14 shows a comparison of the quantified BI-RADS mammographic density for the seventeen volunteers against the QBD obtained through the QTUS system as described herein. As shown in FIG. 14, there is a clear correlation between the quantified BI-RADS score and the QBD, although the quantified BI-RADS score is generally roughly 2× the QBD. The difference in the two quantified density values may be attributed to the psycho-visual tendency to overestimate 3D volumes from projections and the presence of topological 3D ‘holes or voids’ within the fibroglandular tissue, which are hidden in projections

It should be understood that the examples and embodiments described herein are for illustrative purposes only and that various modifications or changes in light thereof will be suggested to persons skilled in the art and are to be included within the spirit and purview of this application.

What is claimed is:

1. A method for quantitative assessment of breast density, comprising:
separating exterior voxels from breast voxels of an image of a patient's breast;
segmenting high speed value breast voxels from other breast voxels of a speed map of the patient's breast to generate a first segmented image;
removing, from the first segmented image, breast voxels corresponding to skin tissue of the patient's breast to generate a second segmented image; and
calculating breast density by determining a percentage of the high speed value breast voxels in the second segmented image.

2. The method of claim 1, wherein the image of the patient's breast comprises the speed map, the separating of the exterior voxels from the breast voxels comprising:
performing segmentation using the speed map.

3. The method of claim 1, wherein the image of the patient's breast comprises a reflection map, the separating of the exterior voxels from the breast voxels comprising:
performing segmentation using the reflection map.

4. The method of claim 3, wherein performing segmentation using the reflection map comprises:
using an envelope of a reflected signal in the reflection image to isolate breast tissue from an exterior volume.

5. The method of claim 1, wherein the image of the patient's breast comprises the speed map and an attenuation map, the separating of the exterior voxels from the breast voxels comprising:
performing segmentation using the speed map and the attenuation map.

6. The method of claim 1, wherein the image of the patient's breast comprises an attenuation map, the separating of the exterior voxels from the breast voxels comprising:
performing a thresholding process with respect to the attenuation map.

7. The method of claim 1, wherein the image of the patient's breast comprises an attenuation map, the separating of the exterior voxels from the breast voxels comprising:
reading the attenuation map;
performing an intermediary separation by determining whether a value of each voxel of the attenuation map is larger than a predetermined value; when the value of a voxel of the attenuation image is larger than a predetermined value, assigning the voxel as a breast voxel; otherwise assigning the voxel as an exterior voxel; and
performing at least one morphological operation after the intermediary separation to reassign certain voxels as either the breast voxel or the exterior voxel.

8. The method of claim 1, wherein the image of the patient's breast comprises an attenuation map, the separating of the exterior voxels from the breast voxels comprising:
reading the attenuation map;
identifying voxels positioned at a boundary between a surrounding exterior volume and the breast using the convex nature of the breast;
assigning voxels within the boundary as breast voxels; and
assigning voxels outside the boundary as exterior voxels.

9. The method of claim 1, further comprising:
creating the speed map of a volume containing the patient's breast.

10. The method of claim 9, wherein creating the speed map of the volume containing the patient's breast comprises performing quantitative transmission ultrasound.

11. The method of claim 1, further comprising:
creating the speed map and an attenuation map of a volume containing the patient's breast.

12. The method of claim 11, wherein creating the speed map and the attenuation map of the volume containing the patient's breast comprises performing quantitative transmission ultrasound.

13. The method of claim 1, further comprising:
creating the speed map, an attenuation map, and a reflection map of a volume containing the patient's breast.

14. The method of claim 13, wherein creating the speed map, the attenuation map, and the reflection map of the volume containing the patient's breast comprises performing quantitative transmission ultrasound.

15. A system comprising:
one or more computer-readable storage media having instructions stored thereon that, when executed by a processor, direct the processor to:
separate exterior voxels from breast voxels of a speed map of a patient's breast;
segment high speed value breast voxels from other breast voxels of the speed map to generate a first segmented image;
remove, from the first segmented image, breast voxels corresponding to skin tissue of the patient's breast to generate a second segmented image;
calculate breast density by determining a percentage of the high speed value breast voxels in the second segmented image; and
display at least one of the speed map, the first segmented image, and the second segmented image.
